(19) United States
(12) Patent Application Publication
(10) Pub. No.: US 2010/0025891 A1
(43) Pub. Date: Feb. 4, 2010

(54) Concrete release agent

(75) Inventor: Klaus Droll, Mainz (DE)

Correspondence Address: COLLARD & ROE, P.C., 1077 NORTHERN BOULEVARD, ROSLYN, NY, 11576, US

(73) Assignee: Dyckerhoff AG

(21) Appl. No.: 12/460,586

(22) Filed: Jul. 21, 2009

(30) Foreign Application Priority Data
Jul. 29, 2008 (DE) 10 2008 035 236.5

(51) Int. Cl. B29C 41/42; C04B 40/00

(52) U.S. Cl. 264/334; 106/822; 106/819

(57) ABSTRACT

A concrete release agent, particularly on the basis of mineral oil without solvent, mineral oil with solvent, emulsions, or ester oil, contains nanoparticles that have a photocatalytic effect on organic molecules of the release agent, particularly also such mineral-modified photocatalysts having broader absorption spectra that also act in visible light, in an amount that brings about the result that the organic components of the release agent are photocatalytically decomposed by the effect of daylight after the form/mold has been removed from the concrete. In this connection, the organic components are removed from the concrete surface via the formation of volatile reaction substances.

### CROSS REFERENCE TO RELATED APPLICATIONS

Applicant claims priority under 35 U.S.C. §119 of German Application No. 10 2008 035 236.5 filed Jul. 29, 2008.

### BACKGROUND OF THE INVENTION

1. Field of the Invention

The invention relates to a release agent that can be used as a construction aid in concrete technology, to prevent a concrete part from sticking to the form for the part in concrete work.

2. The Prior Art

In general, release agents are applied to the forms of locally poured concrete parts, for example, before the fresh concrete is poured, and to molds of pre-finished concrete parts, in a layer of 10-50 μm. They are supposed to facilitate removal of the forms/molds, and thereby increase the number of technically possible uses of the forms and molds.

Additional demands are made on release agents. With regard to concrete technology, no impairment of the hardening processes of the fresh concrete is allowed to occur. Surface phenomena such as release of sand from or severe chalking of the hardened concrete surfaces must be avoided. Such surface phenomena must be avoided particularly if a subsequent coating such as paint or stucco is intended to be applied to the hardened concrete surface. With regard to processing, a thin, efficient application with resistance to the influences of weathering and a low tendency to absorb contaminants must be guaranteed. The release agent is also supposed to protect the form/mold against the influences of weathering and to reduce the effort required to clean the form/mold skin. Furthermore, environmental compatibility and work hygiene are expected of a contemporary release agent.

The release agents—also called concrete release agents or unforming/unmolding agents—can contain additives such as wetting agents, detergents or surfactants, for example, or active substances that are supposed to protect forms/molds made of organic materials, such as wood or plastic, for example, against rotting, for example, and forms/molds made of metal against corrosion.

Known additives are, for example, rust protectants, anti-oxidants, anti-pore-forming agents, preservatives, creep aids, water displacers, wood sealers, and emulsifiers.

Basic materials for concrete release agents are essentially organic substances. Such organic substances include mineral oils with and without solvents, separating oil emulsions based on water with vegetable oils, esters, in part also alcohols and fatty acids, wax solutions, release varnishes, ester oil concrete release agents based on carrier substances of vegetable oils, such as rice oil or rapeseed oil, or ester oils with and without additives, in each instance. Biodegradable unforming/unmolding agents or release agents on the basis of such biodegradable unforming/unmolding agents have been developed, which are also used as emulsions. The biodegradation is supposed to prevent solvents or oil-containing products or both from getting into the soil, and the release agent from remaining on the concrete surface, because release agent on the concrete surface can optically impair the surface, for example by forming spots, or can make the application of paint or mortar difficult. Biodegradation, however, takes place very slowly.

As mentioned previously, very many demands are made on release agents. With regard to concrete technology, no impairment of the hardening processes of the fresh concrete is allowed to occur. Surface phenomena such as release of sand from or severe chalking of the hardened concrete surfaces must be avoided. Such surface phenomena must be avoided particularly if a subsequent coating such as paint or stucco is intended to be applied to the hardened concrete surface. With regard to processing, a thin, efficient application with resistance to the influences of weathering and a low tendency to absorb contaminants must be guaranteed.

The release agent is also supposed to protect the form/mold against the influences of weathering and to reduce the effort required to clean the form/mold skin. Furthermore, environmental compatibility and work hygiene are expected of a contemporary release agent.

Finally, the release agents are also supposed to be resistant to light, particularly UV radiation, both before and during use.

### SUMMARY OF THE INVENTION

It is an object of the invention to provide a release agent that acts during the set-up phase and decomposes relatively rapidly after removal of the form/mold so that no harmful substance from the release agent can get into the soil and also no residues that impair the surface remain on the concrete surface.

These and other objects are achieved according to one aspect of the invention by a concrete release agent, particularly on the basis of mineral oil without solvent, mineral oil with solvent, emulsions, or ester oil, containing nanoparticles that have a photocatalytic effect on organic molecules of the release agent, particularly having broader absorption spectra that also act in visible light, in an amount that brings about the result that the organic components of the release agent are photocatalytically decomposed by means of the effect of daylight after the form/mold has been removed from the concrete, and in this connection, are removed from the concrete surface by means of the formation of volatile substances. Advantageous further developments of the invention are discussed below.

In accordance with the invention, a release agent is used for coating form/mold surfaces, particularly those having a currently known composition, which agent has had added to it photocatalytically active nanoparticles. For example, photocatalytically active nanoparticles of TiO₂ and/or ZnO may be added to the release agent or other photocatalytically active nanoparticles, particularly also mineral-modified nanoparticles having a broader absorption spectrum, in each instance (e.g. DE 10 2005 057 770 A1, DE 10 2005 057 747 A1, WO 01/00541 A1), which act on organic molecules of release agents, forming oxygen-rich radicals, as the result of excitation by UV radiation, visible light, or both.

It is practical if the particle sizes lie between 5 and 500 nm, particularly 20 and 100 nm. The nanoparticles have the property of initiating photocatalysis under irradiation with daylight, for example, during which organic molecules situated in the vicinity of these nanoparticles oxidize and form CO₂. Accordingly, the organic substances of the carrier substance, namely the release agents, are oxidized at ambient temperature, and volatile reaction substances are formed. The carrier substance is thus removed from the concrete surface, on which release agent always remains, adhering to it, after unforming/unmolding, as it does on the form/mold surface.

Oxidation of the release agent components surprisingly leaves a sufficient amount of nanoparticles permanently adhering to the concrete surface and/or in the surface region. The nanoparticles primarily settle in depressions, in the capillary system and pores of the concrete surface.

These adhering nanoparticles synergistically bring about the known purification of the surrounding air, which contains nitrous oxides such as NOₓ or NO and SO₂, via photocatalytic activity.

The invention also relates, in general, to coating of component surfaces, particularly of concrete surfaces. According to this aspect, a carrier substance that contains the nanoparticles described above and that is essentially or completely decomposed, without any residue, on the basis of the photocatalysis triggered by the nanoparticles, is used, whereby the photocatalytic nanoparticles are permanently left behind on the surface of the component, or in the surface region. Examples of such carrier substances are, along with the release agents mentioned, for example: wax emulsions, polymer dispersions, film-forming concrete treatment agents (curing agents), which are described, for example, in Zement-Merkblatt [Cement Bulletin], Betontechnik [Concrete Technology], B8, 11.2002, “Nachbehandlung von Beton” [Post-treatment of concrete] (www.BDZement.de).

Placement of metal oxide film coatings on construction elements exposed to light, particularly also on concrete construction elements, is known (EP 590 477 A1). For example, titanium dioxide, iron oxide, silver oxide, copper oxide, tungsten oxide, aluminum oxide, silicon oxide, zinc oxide as well as strontium titanate are used as metal oxides. The film coating is supposed to be durable. For this reason, the coating is heat-treated so that the film then does not break or peel off (DE 693 11 866 T2). In this connection, it is also known to add a second metal to the films that contain the nanoparticles having the photocatalytic properties, in order to reinforce the photocatalytic effect of the nanoparticles.

According to the invention, 0.1 to 50 wt.-%, particularly 1 to 30 wt.-% nanoparticle powder can be present in the release agent. In this way, an amount in excess of that necessary for decomposition of the release agent also remains available on the surface of the concrete for the self-cleaning effect.

The basis for the release agents is all known release agent compositions (biodegradable compositions and particularly those that are not degradable, or degradable only with difficulty), into which the photocatalyst nanoparticles are mixed, for example in powder form and/or as a sol/gel formulation and/or in the form of a nanoparticle dispersion. These compositions can involve water-emulsified release agents (emulsions or ester oils) or release agents based on hydrocarbon (mineral oils or mineral oils with solvents such as test benzenes as the solvent). The additive amount is selected so that decomposition and volatilization can take place within 1 to 24 hours, particularly 1 to 4 hours, under the effect of daylight.

The concrete release agent may contain 2 to 14 wt.-%, particularly 8 to 12 wt.-% nanoparticle powder, particularly nano-anatase pigment powder or zinc oxide nanoparticle powder. The release agent may contain a 30 to 50% aqueous nanoparticle suspension.

The following additive amounts, for example, have proven themselves:
2-14, particularly 8-12 wt.-% nano-anatase pigment powder,
or
15-30, particularly 18-25 wt.-% TiO₂ suspension (30-50%) essentially composed of TiO₂ nanoscaled particles and water,
remainder release agent, in each instance.

The invention thus essentially concerns itself with modifying concrete surfaces by use of specially equipped release agents. These release agents bring about not only their release effect during unforming/unmolding, but in addition, a surface modification of the concrete, to the effect that the sols that are mixed in crystallize out later, and the nanopigments are built into the concrete surface and have a photocatalytic effect upon irradiation with daylight or UV light, respectively.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a diagram comparing the photocatalytic decomposition of a commericially available release agent with a release agent in accordance with an embodiment of the invention; and

FIG. 2 is a diagram showing the photocatalytic effectiveness of the concrete surface following decomposition of a release agent in accordance with an embodiment of the invention.

### DETAILED DESCRIPTION OF PREFERRED EMBODIMENTS

The release agent decomposition via nanoscaled TiO₂ particles will be illustrated using the following example.

Four concrete panels were produced from white concrete. Furthermore, two release agent samples were produced from a commercially available release agent emulsion that contains vegetable oil as a release-active substance. The one sample, 1 (TM1) contained

30 wt.-% release agent

2 wt.-% rhodamine

68 wt.-% water

The other sample, 2 (TM2) contained

30 wt.-% release agent

2 wt.-% rhodamine

5 wt.-% TiO₂ nanoparticle powder

63 wt.-% water

Rhodamine is known to be an organic, intensely red pigment that also serves as a photocatalytically decomposable indicator substance, which changes optically during the process of decomposition. Water was added so that the thickening of the mixture caused by the TiO₂ nanoparticles can be compensated, and a relatively thin layer can be applied.

The two release agent samples 1 and 2 were applied to a concrete panel in a thin layer, in each instance, and the layers were exposed once to sunlight and once to artificial UV(A) radiation, in each instance. In this connection, a colorimetric measurement (L-a-b system) was carried out, in order to determine the color loss of the rhodamine, which indicates the decomposition of the organic components of the concrete release agent.

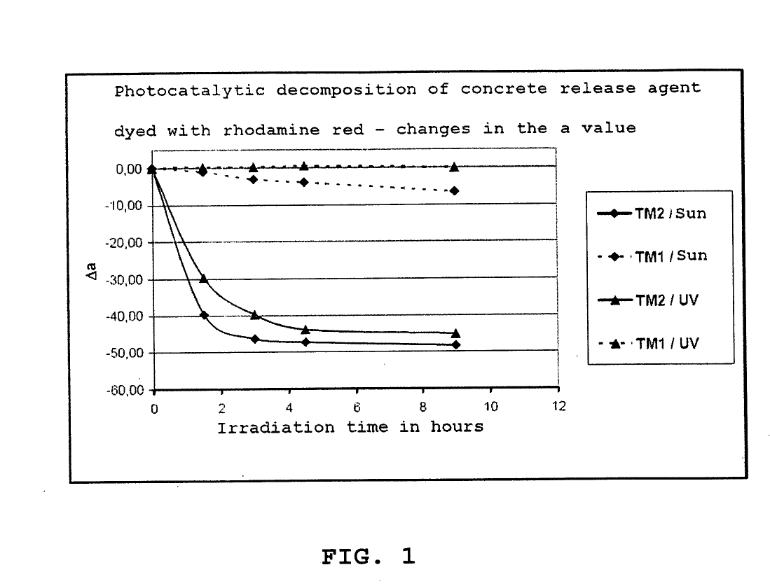

The result is shown in FIG. 1.

The change in the a value (red value) is plotted over time (bleaching=decomposition of the red-dyed concrete release agent). It can be seen in FIG. 1 that the release agent that contains TiO₂ (TM2) is almost completely decomposed under sun irradiation and UV radiation, in comparison with the sample TM1, which does not contain any TiO₂.

The TiO₂ nanoparticles remained on the concrete plate surface and were available for further photocatalytic reactions and/or effects.

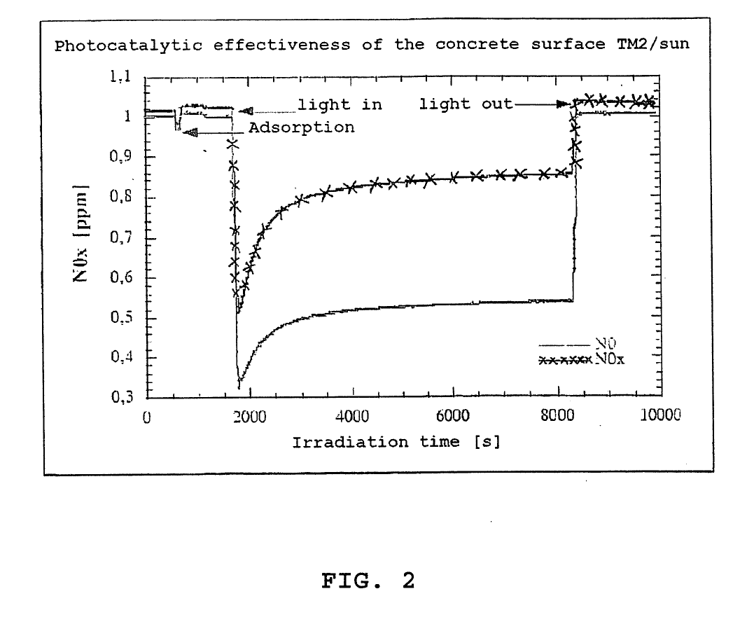

FIG. 2 shows the photocatalytic effectiveness of the concrete surface TM2/sun (after the release agent decomposition, see FIG. 1) resulting from the decomposition of NOₓ and NO on a concrete sample surface of 5×10 cm in a gas flow of 3 l/m, with an NOₓ and NO concentration of 1 ppm at an irradiation with UV(A) light of 1 mW/cm2 (measured using an NO/NOₓ analyzer with fluorescence detector).

At the beginning of the measurement, a gas stream of 1 ppm NOₓ or NO, respectively, is allowed to flow over the sample surface in the dark (without UV(A) irradiation) for approximately 30 minutes. In this connection, no decomposition of these gases is determined.

After approximately 30 minutes, UV(A) light is then turned on. The NOₓ or NO content, respectively, above the sample surface is then immediately reduced by 50% or 70%, respectively, and it drops to equilibrium values at 18% or 46%, respectively, after another 100 minutes of irradiation.

After 100 minutes, the UV(A) light is turned off again, and the starting values in the gas stream are resumed once again.

Although only a few embodiments of the present invention have been shown and described, it is to be understood that many changes and modifcations may be made thereunto without departing from the spirit and scope of the invention.

What is claimed is:

1. A concrete release agent comprising:
(a) a release agent composition containing organic components selected from the group consisting of mineral oil without solvent, mineral oil with solvent, an emulsion, and ester oil; and
(b) nanoparticles contained in the release agent composition, said nanoparticles having a photocatalytic effect on the organic components of the release agent compositionn, said nanoparticles having an absorption spectra that acts at least in visible light and being present in the release agent composition in an amount that causes the organic components of the release agent composition to photocatalytically decompose under daylight to form removable volatile reaction substances.

2. The concrete release agent according to claim 1, wherein the nanoparticles comprise at least one of TiO₂ particles and ZnO particles.

3. The concrete release agent according to claim 1, wherein the nanoparticles have sizes between 5 and 500 nanometers.

4. The concrete release agent according to claim 3, wherein the nanoparticles have sizes between 20 and 100 nanometers.

5. The concrete release agent according to claim 1, wherein the nanoparticles are mixed in the release agent composition in at least one form selected from the group consisting of a powder form, a sol/gel formulation, and a nanoparticle dispersion.

6. The concrete release agent according to claim 1, wherein the nanoparticles are contained in the release agent composition as a nanoparticle powder selected from the group consisting of a nano-anatase pigment powder and a zinc oxide nanoparticle powder in the amount of 2 to 14 wt.-%

7. The concrete release agent according to claim 6, wherein the amount of nanoparticles contained in the release agent composition is 8 to 12 wt.-%.

8. The concrete release agent according to claim 1, wherein the nanoparticles are contained in the release agent composition as an aqueous nanoparticle suspension in the amount of 30 to 50 wt.-%.

9. The concrete release agent according to claim 1, wherein the release agent composition is not biodegradable or biodegradable only with difficulty.

10. A method of removing concrete from a form or mold comprising:
(a) providing a concrete release agent comprising a release agent composition containing organic components selected from the group consisting of mineral oil without solvent, mineral oil with solvent, an emulsion, and ester oil and nanoparticles contained in the release agent composition having a photocatalytic effect on the organic components of the release agent composition, the nanoparticles having an absorption spectra that acts at least in visible light and being present in the release agent composition in an amount that causes the organic components of the release agent composition to photocatalytically decompose under daylight to form removable volatile reaction substances;
(b) applying the release agent to a surface of the concrete in the form or mold;
(c) subjecting the release agent to daylight to photocatalytically decompose the organic components of the release agent composition to form volatile reaction substances after the form or mold has been removed from the concrete; and
(d) removing the volatile reaction substances from the surface of the concrete.

11. The method according to claim 10, wherein the release agent is applied to the surface of the concrete by coating a form or mold surface of the form or mold with the release agent, the release agent adhering to the surface of the concrete following removal of the concrete from the form or mold and being subsequently removed from the surface of the concrete following photocatalytical decomposition of the organic components of the release agent composition.
